(19) United States
(12) Patent Application Publication
(10) Pub. No.: US 2008/0290312 A1
(43) Pub. Date: Nov. 27, 2008

(54) Fluid control valve

(75) Inventors: Katsunori Hirose, Kasugai-shi (JP); Masayoshi Morimoto, Nagoya-shi (JP)

Correspondence Address: OLIFF & BERRIDGE, PLC, P.O. BOX 320850, ALEXANDRIA, VA, 22320-4850, US

(73) Assignee: CKD CORPORATION, Komaki-Shi (JP)

(21) Appl. No.: 12/149,229

(22) Filed: Apr. 29, 2008

(30) Foreign Application Priority Data
May 21, 2007 (JP) 2007-134333

(51) Int. Cl. F16K 1/00

(52) U.S. Cl. 251/333

(57) ABSTRACT

A fluid control valve comprises a diaphragm formed of a plurality of circular thin metal plates laminated one on another, the diaphragm being placed to be movable into or out of contact with a valve seat for closing and opening the valve. Each thin metal plate has a warp in a predetermined direction due to rolling anisotropy, and the thin metal plates are laminated with the directions of respective warps coinciding with one another in such a manner that variations in lift amount of the diaphragm are decreased.

### BACKGROUND OF THE INVENTION

1. Field of the Invention

The present invention relates to a fluid control valve including a diaphragm made of metal plates and being arranged to perform valve opening/closing by bringing the metallic diaphragm into contact with or out of a valve seat. Specifically, the present invention relates to a technique of decreasing variations in lift amount of the metallic diaphragm and contributing to enhancement of the flow characteristic and the action durability.

2. Description of Related Art

Heretofore, a fluid control valve including a metallic diaphragm has been employed as an opening/closing valve for gas supply which is used for a semiconductor manufacturing device. Compared to a diaphragm made of resin, use of the metallic diaphragm is advantageous for the reasons that wasted space inside a valve chamber can be reduced, gas is replaced efficiently, and occurrence of particles from a contact portion of the metallic diaphragm can be restrained.

Basic structure of the metallic diaphragm is disclosed, for example, in Japanese Unexamined Patent Publication No. 10 (1998)-318385A and Japanese Unexamined Patent Publication No. 2004-19735A.

JP10-318385A discloses an art related to a metallic diaphragm type flow regulating valve. According to JP10-318385A, a metallic diaphragm having a plurality of laminated plates identical in material is held in the body of the flow regulating valve. This valve is configured to shut off or to pass a fluid by bringing one surface of the metallic diaphragm into direct contact with or out of a valve seat.

In JP10-318385A, the metallic diaphragm is constituted by the plates welded or bonded to one another by means of spot welding, an adhesive or the like. Further, a plurality of metallic thin plates each having smaller diameter than the internal diameter of an elastically deforming portion is welded or bonded together to reinforce the metallic diaphragm. Consequently, the metallic diaphragm can provide higher rigidity in its center than its peripheral portion. As a result, it is possible to achieve the metallic diaphragm type flow regulating valve which is excellent in closing performance by small force when the valve is fully closed.

JP2004-19735A discloses an art related to diaphragm structure. According to JP2004-19735A, a PFA (perfluoro-alkoxyethylene) layer is formed on a surface of a metallic diaphragm which will be exposed to gas. Likewise, another PFA layer is formed on a stem contact surface opposite from the surface which will be exposed to gas. When a valve is closed, the surface formed with the PFA layer is brought into contact with a valve seat. This configuration enhances corrosion resistance and realizes high sealing performance by elasticity of the PFA layer.

### SUMMARY OF THE INVENTION

However, the above-mentioned prior arts; JP10-318385A and JP 2004-19735A have such a problem that undesired variations or changes in lift amount of the metallic diaphragm occur.

Since the flow characteristic of the fluid passing through the fluid control valve changes depending on the lift amount of the metallic diaphragm, the dimensions of the fluid control valve needs to be measured in an extremely accurate manner. At the same time, the metallic diaphragm is made of a plurality of thin metal plates in order to enhance the fatigue resistance and to function as a pressure separation wall. Consequently, the applicant has confirmed that the metallic diaphragm formed of laminated thin metal plates as mentioned above is liable to cause variations in lift amount.

Presumably, after the shaping process, each thin metal plate warps due to its rolling anisotropy, and accordingly a lift amount varies depending on the lamination orientations of the warped plates. The rolling anisotropy means the state that the material strength of the rolled thin metal plate differs between a rolling direction and a direction perpendicular to the rolling direction when metal material is rolled.

For example, there is a case confirmed that the first metal plate is less deformed when the second thin metal plate is laminated on the first thin metal plate with the directions of respective warps being different from each other because the second metal plate disturbs the deformation of the first metal plate.

As mentioned above, no matter how accurately a body of the fluid control valve is manufactured, variations in lift amount of the metallic diaphragm of the fluid control valve could cause flow variations or fluctuations because of the differences of each individual metallic diaphragm.

The present invention has an object to overcome the above problem and to provide a fluid control valve with fewer variations in lift amount of a metallic diaphragm and a diaphragm for the fluid control valve.

To achieve the above object, the present invention provides a fluid control valve having the following configurations.

(1) According to one aspect of the invention, a fluid control valve comprises a diaphragm formed of a plurality of circular thin metal plates laminated one on another, the diaphragm being placed to be movable into or out of contact with a valve seat for closing and opening the valve. Each thin metal plate has a warp in a predetermined direction, and the thin metal plates constituting the diaphragm are laminated with the directions of respective warps coinciding with one another.

(2) In the fluid control valve (1), each thin metal plate has rolling anisotropy and the warp has occurred thereon after the shaping process of the thin metal plates.

(3) In the fluid control valve (1) or (2), preferably, the thin metal plates include a first thin metal plate and a second thin metal plate. The first thin metal plate is formed with a first reference mark on a part of a surface thereof, and the second thin metal plate is formed with a second reference mark on a part of a surface thereof at a position corresponding to the first reference mark. The first and second thin metal plates are laminated so as to align the first and second reference marks to make the respective warps coincide with each other.

(4) In the fluid control valve (3), preferably, the first reference is provided in the form of a first cutout end, and the second reference is provided in the form of a second cutout end.

(5) In the fluid control valve (3), preferably, the first reference is provided in the form of a first protrusion formed by pressing a part of the first thin metal plate, and the second reference is provided in the form of a second protrusion formed by pressing a part of the second thin metal plate.

(6) In any one of the fluid control valves (1) to (5), preferably, a plurality of thin metal plates are laminated in such a manner that they are temporarily assembled and then vibrated to make the respective warps coincide with one another.

Operations and advantages of the fluid control valve having the above configurations will be explained below.

According to the configuration (1), the fluid control valve comprises the diaphragm formed of the plurality of circular thin metal plates laminated one another, the diaphragm being placed to be movable into or out of contact with the valve seat for closing and opening the valve. Each thin metal plate has a warp in the predetermined direction, and the thin metal plates constituting the diaphragm are laminated with the directions of respective warps coinciding with one another.

As above mentioned, the metal plates are laminated with the warps coinciding one another to form the diaphragm and mounted in the fluid control valve. This makes it possible to reduce variations in lift amount of the diaphragm during operation of the fluid control valve to allow fluid to flow.

Each thin metal plate has rolling anisotropy and therefore may warp in one direction during the process of being formed into a spherical shell shape. In the case where warps of the thin metal plates occur in this way during the shaping process, the thin metal plates are laminated so that the warps coincident with one another to form the diaphragm. The fluid control valve in which such diaphragm is mounted can decrease variations in lift amount of the diaphragm.

As described in the aforementioned problems to be solved, if the warps of the thin metal plates disagree, the respective warps of the thin metal plates mutually interfere with one another, causing decreases and variations in lift amount of the diaphragm. Accordingly, the diaphragm comprising the thin metal plates laminated with the directions of respective warps coinciding with one another is mounted in the fluid control valve. Consequently, the fluid control valve capable of decreasing variations in lift amount of the diaphragm can be provided.

In the configuration (2) to provide the fluid control valve (1), warps of the circular thin metal plates occur after the shaping process due to rolling anisotropy of the thin metal plates, and accordingly the thin metal plates are laminated so that the rolling directions coincide with one another. This can make the warps of the thin metal plates coincident with one another.

A thin metal plate for the diaphragm is rolled to have a thickness of several tens percent of the thickness of the original material in order to enhance the fatigue strength. Then, the thin metal plate is formed into a plurality of circular plates. These circular thin metal plates are laminated to form the diaphragm.

Metal will warp after a producing or shaping process because its rolling anisotropy is caused when rolled. When a plurality of thin metal plates laminated to form the diaphragm without making respective warps coincident with one another, the warps of the thin metal plates are likely to disturb deformation of the diaphragm and decrease lift amount of the diaphragm.

Consequently, the rolling directions of the thin metal plates are aligned to make the warps thereof coincide with one another. This can decrease variations in lift amount of the diaphragm of the fluid control valve.

In addition, in the configuration (3) to provide the fluid control valve (1) or (2), the thin metal plates include the first thin metal plate and the second thin metal plate, and the first thin metal plate is formed with the first reference mark on a part of the surface thereof, and the second thin metal plate is formed with the second reference mark on the part of the surface thereof at the position corresponding to the first reference mark. The first and second thin metal plates are laminated so as to align the first and second reference marks to make the respective warps coincide with each other. Even if the warps W are hard to identify or distinguish, the first and second thin metal plates can be laminated with the warps coinciding with each other.

After the rolling process but before the press-cutting process of the metal plates, or after the press-cutting process, the reference marks are marked by means of laser marking or the like so that the directions of the warps of the first and second thin metal plates can be easily made coincident with each other.

Various ways besides the laser marking may be adopted for forming the references. For example, the references may be formed by providing cutout end by press-cutting or punching or by forming a protrusion in a part of a thin metal plate by pressing. Moreover, the shapes of the thin metal plate may be modified or changed, or the rolled plate may be colored partly.

In the configuration (4) to provide the fluid control valve (1), the first reference is provided in the form of cutout end by cutting a part of the first thin metal plate, and the second reference is provided in the form of cutout end by cutting a part of the second thin metal plate. Accordingly, the first and second thin metal plates have only to be laminated so that the first and second cutout ends are aligned to make the warps of the first and second thin metal plates coincide with each other.

In the configuration (5) to provide the fluid control valve (3), the first reference is provided in the form of a protrusion formed by pressing a part of the first thin metal plate, and the second reference is provided in the form of a protrusion formed by pressing a part of the second thin metal plate. Accordingly, the first and second thin metal plates have only to be laminated so that the first and second protrusions are aligned to make the warps of the first and second thin metal plates coincide with each other.

Furthermore, the protrusions put one on the other can prevent the first and second thin metal plates from becoming displaced after lamination, and hence avoid displacement of the warps when the diaphragm is mounted in the fluid control valve.

In the configuration (6) to provide any one of the fluid control valves (1) to (5), the thin metal plates include the first thin metal plate and the second thin metal plate, the first and second thin metal plates are assembled in such a manner that they are temporarily laminated and then vibrated to make the respective warps coincide with each other.

This application of vibration to the first and second thin metal plates allows the plates to move or turn, causing the respective warps to coincide with each other, when the warps of the first and second thin metal plates are large enough to be identified.

### BRIEF DESCRIPTION OF THE DRAWINGS

FIG. 1 is a sectional view showing a fluid control valve in a first embodiment according to the present invention;

FIG. 2 is an enlarged view showing a part X in FIG. 1;

FIG. 3 is a schematic view showing a state where a first thin metal plate and a second thin metal plate are laminated one on the other in the first embodiment;

FIG. 4 is a schematic view showing a state where a metallic diaphragm is mounted in a passage block in the first embodiment;

FIG. 5 is a schematic view showing a state where the first thin metal plate and the second thin metal plate are laminated one on the other in a second embodiment;

FIG. 6 is a schematic view showing a state where the first thin metal plate and the second thin metal plate are laminated one on the other in a third embodiment; and

FIG. 7 is a schematic view showing a state where the first thin metal plate and the second thin metal plate are laminated one on the other in a fourth embodiment.

### DETAILED DESCRIPTION OF THE PREFERRED EMBODIMENTS

A detailed description of preferred embodiments of a fluid control valve according to the present invention will now be given referring to the accompanying drawings.

First of all, a configuration of the first embodiment according to the present invention will be explained.

### First Embodiment

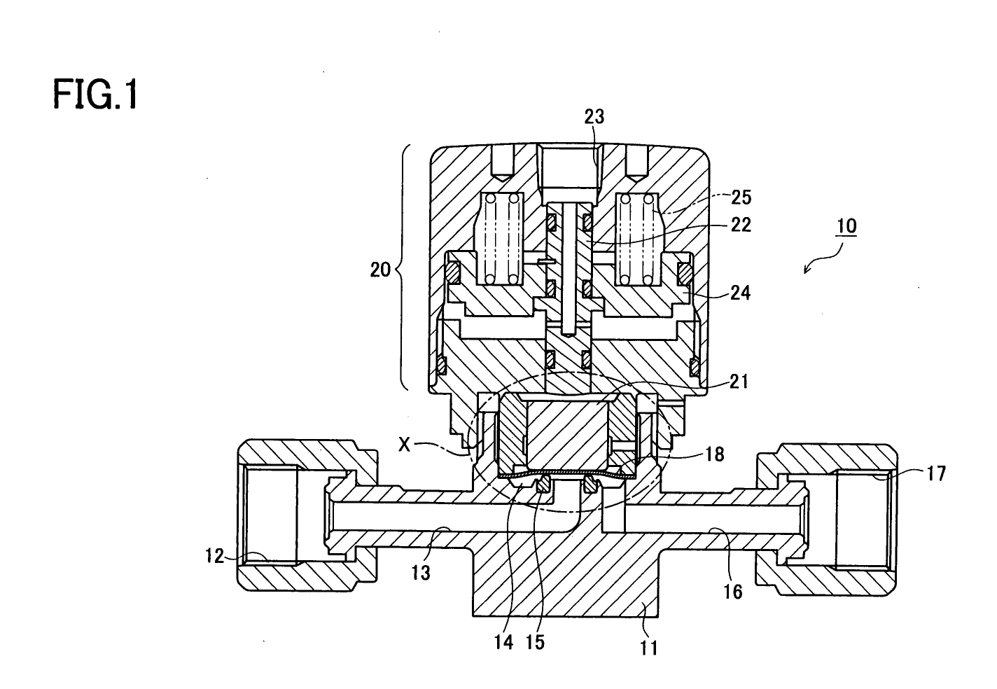

FIG. 1 is a sectional view of a fluid control valve 10 in the first embodiment.

A fluid control valve 10 includes a passage block 11 and a drive unit 20. The passage block 11 is made of stainless steel such as SUS316L which is excellent in corrosion-resistance and is mechanically processed to have the following configuration. The passage block 11 has an IN port 12 and an OUT port 17. A first flow passage 13 connected to the IN port 12 communicates with a valve chamber 14. This valve chamber 14 is connected to the OUT port 17 through a second passage 16. In short, gas flowing from a primary side into the IN port 12 is supplied to a secondary side through the valve chamber 14 and the OUT port 17.

The valve chamber 14 includes a valve seat element 15 with which a metallic diaphragm 18 comes into or out of contact. The valve seat element 15 includes a valve seat portion made of fluorocarbon resin such as PCTFE. The metallic diaphragm 18 is supported by the passage block 11 and the drive unit 20 which firmly hold the outer peripheral part of the metallic diaphragm 18.

The metallic diaphragm 18 is made of a plurality of laminated thin metal plates. Mostly, the thin metal plate is formed of Ni alloy or the like with high fatigue strength. The manufacture method of the metallic diaphragm 18 will be explained later.

The metallic diaphragm 18 is in contact with a stem 21 which is moveable up and down by a shaft 22. This shaft 22 is internally formed with a driving air supply port 23. Operating air supplied through the driving air supply port 23 causes a piston 24 to move up. The piston 24 is urged by a spring 25 in the valve closing direction. When supply of the operating air through the driving air supply port 23 is stopped, the piston 24 is moved down by the force of the spring 25 to close the valve.

The fluid control valve 10 of the present embodiment is normally closed. A normally-opened-type fluid control valve is also basically the same in structure as above. Therefore, the structure of the normally-closed-type fluid control valve is explained below.

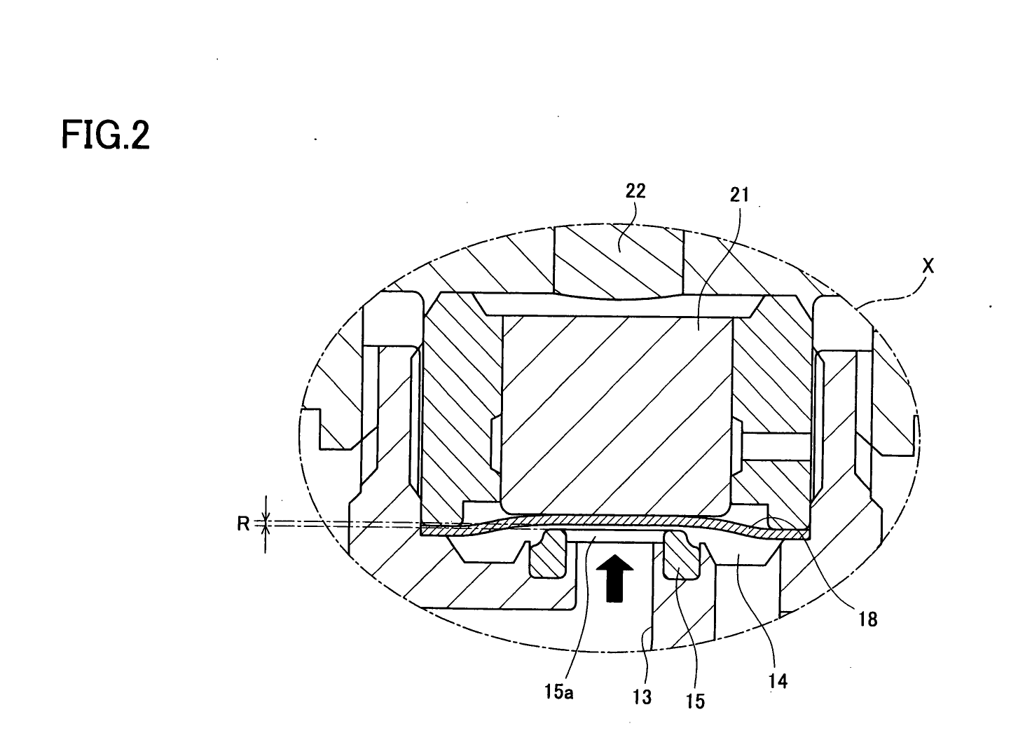

FIG. 2 is an enlarged view of a part X in FIG. 1, showing the metallic diaphragm 18 and its surrounding parts.

The metallic diaphragm 18 is brought into contact with or out of the valve seat element 15 to shut off or open a valve hole 15a of the valve seat element 15. As mentioned above, upward and downward movement of the metallic diaphragm 18 is associated with the action of the shaft 22 and controlled by the operating air.

Lift amount R of the metallic diaphragm 18 is a distance between an upper surface of the valve seat element 15 facing the metallic diaphragm 18 and a lower surface of the metallic diaphragm 18. Then, a flow rate of gas allowed to flow through the fluid control valve 10 is determined by the lift amount R of the metallic diaphragm 18.

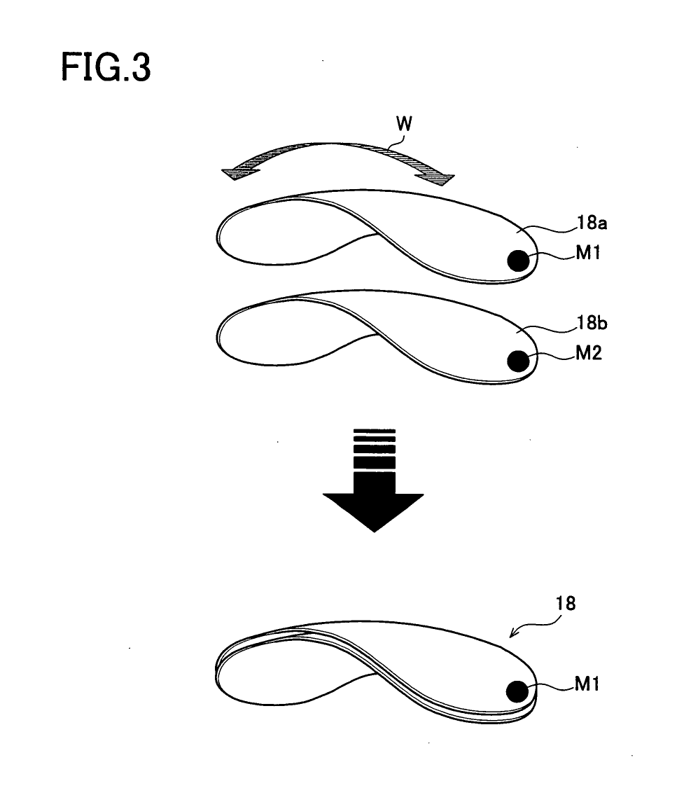

FIG. 3 is a schematic view showing a state where a first and second thin metal plates 18a and 18b are laminated one on the other. The first and second thin metal plates 18a and 18b are illustrated as warping intentionally largely as indicated an arrow W than actual to facilitate understanding of warp.

Manufacturing process for the metallic diaphragm 18 is explained below.

The first and second thin metal plates 18a and 18b constituting the metallic diaphragm 18 are formed into spherical shell shape with about several hundreds μm in thickness by rolling, pressing, and other processes. During the rolling process, a metal plate material is rolled to be stretched to have a thickness of several tens percent of the original thickness. At that time, numerous dislocation lines occurs inside the material, causing the material to harden, which results in increased fatigue strength. Consequently, action durability of the metallic diaphragm 18 can be enhanced.

However, the rolling process causes residual stress to be generated inside the metal. This residual stress is released in the following process and warp W as shown in FIG. 3 is brought about accordingly.

The applicant has confirmed that the warp W is largely influenced by the rolling direction in the rolling process.

In the course of rolling the metal plate to make thinner into a thin metal plate, the metal plate is compressed and stretched in one direction. This compressing and stretching direction is referred to as a rolling direction. The residual stress is generated inside the rolled thin metal plates in the rolling direction. When the residual stress is then released in another process following the rolling process, the warp W is caused by the release of the residual stress, deforming the thin metal plates in a direction perpendicular to the rolling direction. In other words, the warp W of each of the first and second thin metal plates 18a and 18b is caused by the residual stress generated in the rolling direction.

The metallic diaphragm 18 is made of the first and second thin metal plates 18a and 18b formed as above and laminated so that the warps W are coincident with each other. Two thin metal plates are laminated to form the metallic diaphragm 18 in the first embodiment, but the number of plates to be laminated can be determined based on the pressure of the gas allowed to pass through the fluid control valve 10 or on the lift amount R. Thus, three or more plates may be laminated as required.

Prior to manufacturing the metallic diaphragm 18 from the first and second thin metal plates 18a and 18b, the first thin metal plate 18a is marked with a first reference mark M1 and the second thin metal plate is marked with a second reference mark M2 as shown in FIG. 3.

The first reference mark M1 and the second reference mark M2 are marked by means of a laser marker or the like not shown. A laser marking device preferably has the function of marking visible marks on the surfaces of the first and second thin metal plates 18a and 18b.

Shapes of the first and second reference marks M1 and M2 are not limited particularly. The shape can be simply triangular or circular. Another shape may also be adopted to represent manufacturing lot number, material, size or the like of the diaphragm so that the mark be used as an identifier. Furthermore, a product serial number may be marked in addition to the first and second reference marks M1 and M2 on the surfaces of the first and second thin metal plates 18a and 18b.

The first and second reference marks M1 and M2 on the surfaces of the first and second thin metal plates 18a and 18b are marked after the rolling process by the laser marker which moves in an orthogonal direction to the rolling direction, for example. The reference marks remain visible even after the first and second thin metal plates 18a and 18b are formed into the spherical shell shape. In other words, the first and second reference marks M1 and M2 function as signs to indicate the rolling direction after the first and second thin metal plates 18a and 18b are formed into the spherical shell shape.

In this way, the first and second reference marks M1 and M2 on the first and second thin metal plates 18a and 18b function as a marking to indicate the rolling direction of the first and second thin metal plates 18a and 18b. That is to say, the metallic diaphragm 18 with the first and second thin metal plates 18a and 18b whose warps W coincide with each other can be produced if only the first and second reference marks M1 and M2 are aligned with each other.

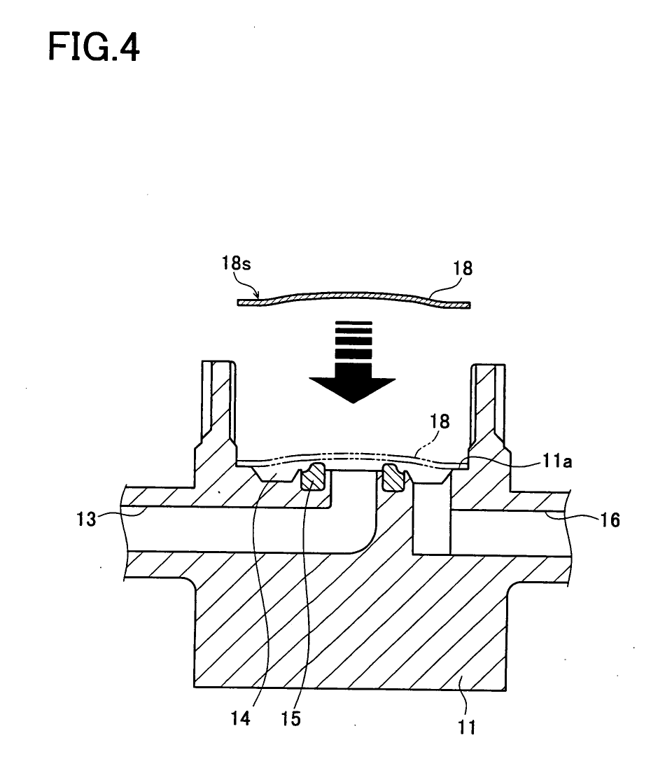

FIG. 4 is a schematic view showing a state where the metallic diaphragm 18 is mounted in the passage block 11.

The metallic diaphragm 18 formed in a manner as mentioned above is placed onto a seating surface 11a formed in the passage block 11. The metallic diaphragm 18 has a peripheral end 18s circumferentially formed with a predetermined width, and the center portion of the metallic diaphragm 18 is slightly convex in a spherical shell shape.

When the metallic diaphragm 18 is placed in the passage block 11, the peripheral end 18s is in contact with the seating surface 11a and the center portion of the metallic diaphragm 18 is out of contact with the valve seat element 15. Then, the drive unit 20 is mounted onto the passage block 11. The peripheral end 18s of the metallic diaphragm 18 is therefore held between the passage block 11 and the drive unit 20 so that the metallic diaphragm 18 is supported in place. Further, the passage block 11 is preferably provided with a mark corresponding to the first reference mark M1 or the second reference mark M2 to reduce individual differences among the fluid control valves 10.

The thus completed fluid control valve 10 is operated to supply operating air to the drive unit 20 to move the metallic diaphragm 18 into contact with or out of the valve seat element 15, thereby allowing the gas supplied through the IN port 12 of the passage block 11 to flow through the valve chamber 14 into the secondary side through the OUT port 17.

The fluid control valve 10 according to the first embodiment has the following advantages.

As the first advantage, the fluid control valve 10 includes the metallic diaphragm 18 formed of the laminated first and second thin metal plates 18a and 18b with respective warps W coinciding with each other so that the variations in the lift amount R of the metallic diaphragm 18 can be decreased.

As mentioned in SUMMARY OF THE INVENTION, the variations in the lift amount R of the metallic diaphragm 18 is caused by disagreement of the warps W of the thin metal plates, that is, a difference in the rolling direction according to the applicant's investigation.

As mentioned above, the metallic diaphragm 18 is constituted of the first and second thin metal plates 18a and 18b laminated each other. The first and second thin metal plates 18a and 18b having the rolling anisotropy are likely to warp (W) after the aforementioned processes.

If the warps W of the first and second thin metal plates 18a and 18b disagree, the metallic diaphragm 18 is not allowed to be deformed because the first and second thin metal plates 18a and 18b mutually interfere with deformation due to respective warps W. Consequently, the lift amount R is likely to be decreased than expected.

In addition, if the metallic diaphragm 18 is produced while the warps W of the first and second thin metal plates 18a and 18b disagree, there is another problem that the lift amount R remains unstable as well as the problem of the decrease in the lift amount R. Presumably, the lift amount R of the metallic diaphragm 18 is very changeable according to the degree of misalignment of the directions of the warps W.

The decrease in the lift amount R of the metallic diaphragm 18 sometimes accounts for several tens percent of the lift amount R. Therefore, the warp W has huge influence on the variations in the lift amount R of the metallic diaphragm 18.

It has been already confirmed that use of the metallic diaphragm 18 formed of the first and second thin metal plates 18a and 18b wherein the warps W are coincident with each other can decrease variations in the lift amount R of the metallic diaphragm 18. The fluid control valve 10 in the first embodiment therefore makes it possible to provide the metallic diaphragm 18 with fewer variations in the lift amount R thereof.

By the way, if the warps W of the first and second thin metal plates 18a and 18b are visibly large enough for easy lamination of the plates 18a and 18b, the plates 18a and 18b can be laminated with respective warps W being coincident with each other without needing the first and second reference marks M1 and M2. In this case, the references marks M1 and M2 do not have to be provided. However, the first and second reference marks M1 and M2 are preferably provided to facilitate the quality control of products by recording manufacturing history with different lot numbers of the first and second reference marks M1 and M2.

Furthermore, the first and second reference marks M1 and M2 may be designed to represent the size or the material of the thin metal plates. This configuration can reduce installation failure of the metallic diaphragm 18 into the fluid control valve 10.

As the second advantage, the flow characteristics is enhanced by decreasing the variations in the lift amount R.

Flow rate in the fluid control valve 10 is determined by an effective sectional area of a flow passage in the fluid control valve 10. As for the fluid control valve 10 incorporating the metallic diaphragm 18, the narrowest part of the effective sectional area is the space between the metallic diaphragm 18 and the valve seat element 15. In other words, the flow rate is determined by the lift amount R. Therefore, fewer variations in the lift amount R are expected to enhance the flow characteristics.

The lift amount R is likely to vary in a rage of several tens percent due to the warps W. Mostly, the fluid control valve 10 with the metallic diaphragm 18 is employed in a place or system which comparatively requires the flow rate accuracy. Therefore, it is considerably advantageous to restrain the variations in the lift amount R for the purpose of enhancing the flow characteristics.

As the third advantage, action durability of the metallic diaphragm 18 can be enhanced.

As mentioned before, variations in the lift amount R will be caused if the warps W of the first and second thin metal plates 18a and 18b disagree. Due to the variations in the lift amount R, the first and second thin metal plates 18a and 18b partially apply a load on each other. This partial load deteriorates the action durability of the metallic diaphragm 18.

On the contrary, if the warps W of the first and second thin metal plates 18a and 18b are coincide with each other and the lift amount R does not vary due to the warps W, the action durability can be enhanced by reduction of the load.

As explained above, the fluid control valve 10 and the metallic diaphragm 18 thereof in the first embodiment can exhibit the following configuration, operations, and advantages.

(1) The fluid control valve 10 comprises the metallic diaphragm 18 which is made of laminated circular thin metal plates and movable into contact with or out of the valve seat 15 for the valve opening/closing. The metallic diaphragm 18 is constituted of the first thin metal plate 18a and the second thin metal plate 18b whose warps W are coincident with each other. Therefore, the metallic diaphragm 18 comprising the first and second thin metal plates 18a and 18b with respective warps W coinciding each other can be mounted appropriately in the fluid control valve 10.

The metallic diaphragm 18 is mounted in the fluid control valve 10 with the first and second thin metal plates 18a and 18b being coincident in direction of the warps W with each other as mentioned above. Accordingly, during operation of the fluid control valve 10 to allow fluid to flow, the variations in the lift amount R of the metallic diaphragm 18 can be decreased.

(2) As for the fluid control valve 10 according to (1), the warps W of the circular thin metal plates occur after a shaping process due to rolling anisotropy of the thin metal plates, and accordingly the thin metal plates are laminated so that the rolling directions coincide with each other. This can make the warps W of the first and second thin metal plates 18a and 18b coincident with each other.

A thin metal plate for the metallic diaphragm 18 is rolled to have a thickness of several tens percent of the thickness of the original material in order to enhance the fatigue strength. Then, the thin metal plate is formed into a plurality of circular plates. These circular thin metal plates are laminated as the first and second thin metal plates 18a and 18b to form the metallic diaphragm 18.

Metal will warp (W) after a producing or shaping process because its rolling anisotropy is caused when rolled. When such thin metal plates are laminated to form the metallic diaphragm 18 as mentioned in (1), the warps W of the thin metal plates if not coincide with each other are likely to disturb deformation of the metallic diaphragm 18. This may affect the lift amount R of the metallic diaphragm 18. Therefore, when the first and second thin metal plates 18a and 18b formed by press-cutting or the like from the rolled thin metal plates are laminated with respective warps W being coincident with each other, variations in the lift amount R of the metallic diaphragm 18 can be reduced.

(3) The fluid control valve 10 according to (1) or (2) wherein the reference mark M1 is marked on a part of the surface of the first thin metal plate 18a and the reference mark M2 is marked on a part of the surface of the second thin metal plate 18b at a position corresponding to the first reference mark M1, and the first and second thin metal plates 18a and 18b are laminated so as to align the first and second reference marks M1 and M2. Consequently, the first and second thin metal plates 18a and 18b can be laminated with the warps W coinciding with each other even if the warps W are hard to identify.

After the rolling process but before the press-cutting process of the metal plates, or after the press-cutting process, the first and second reference marks M1 and M2 are marked by means of laser marking or the like so that the directions of the warps W of the first and second thin metal plates 18a and 18b can be easily made coincident with each other.

### Second Embodiment

A second embodiment of the invention will be described below.

The second embodiment is substantially the same in structure as the first embodiment excepting the configurations of the first and second thin metal plates 18a and 18b. The following explanation is therefore made with a focus on the differences.

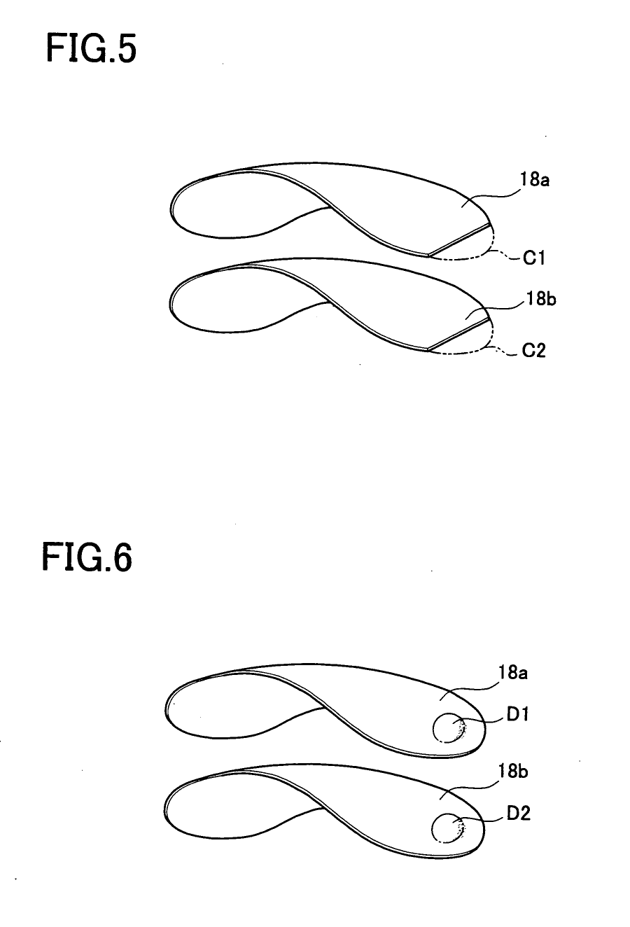

FIG. 5 is a schematic view showing a state where the first thin metal plate 18a and the second thin metal plate 18b are laminated one on the other.

The first thin metal plate 18a is formed with a cutout end C1 in the peripheral end 18s. The second thin metal plate 18b is formed with a cutout end C2 in the peripheral end 18s.

Those cutout ends C1 and C2 can be formed by for example a cutting die providing a circular shape with a corresponding cutout. This method is low in cost.

In FIG. 5, the first and second cutout ends C1 and C2 are illustrated as being large. Alternatively, those cutouts may be formed to be slight enough not to adversely affect the sealing capability of the metallic diaphragm 18. The presence of the first and second cutout ends C1 and C2 can facilitate lamination of the first and second thin metal plates 18a and 18b with respective warps W coinciding with each other as shown in FIG. 3 to form the metallic diaphragm 18.

In the case where the first thin metal plate 18a is provided with the first cutout end C1 and the second thin metal plate 18b is provided with the second cutout end C2 as above, the passage block 11 may be provided with for example a corresponding protrusion serving as a mark for making the warps W coincident in assembling the metallic diaphragm 18 with the passage block 11.

The first and second cutout ends C1 and C2 may be considered as one of available various shapes of the first and second thin metal plates 18a and 18b. Specifically, instead of cutout, the mark may be provided in such a manner that the first and second thin metal plates 18a and 18b is formed with a protrusion or the like extending from at least a part of each plate. As in the first embodiment, this configuration can also contribute to a reduction in variations in lift amount R, improved flow rate characteristics of the fluid control valve 10, and an increased action durability of the metallic diaphragm 18.

The fluid control valve 10 of the second embodiment mentioned above can exhibit the following configuration, operations, and advantages.

(1) The fluid control valve 10 includes the metallic diaphragm 18 which is formed of a plurality of circular thin metal plates and moved into and out of contact with the valve seat element 15 for valve closing and opening. In this valve 10, the first and second circular metal thin plates 18a and 18b are laminated one on the other with the directions of respective warps W coinciding with each other. Accordingly, the metallic diaphragm 18 formed of the first and second thin metal plates 18a and 18b whose warps W coincide is mounted in the fluid control valve 10.

As above, the first and second thin metal plates 18a and 18b are laminated with the warps W coinciding and mounted as the metallic diaphragm 18 in the fluid control valve 10. This makes it possible to reduce variations in lift amount R of the metallic diaphragm 18 during operation of the fluid control valve 10 to allow fluid to flow.

(2) In the fluid control valve 10 mentioned in (1), the first thin metal plate 18a is formed with the first reference mark M1 and the second thin metal plate 18b is formed with the second reference mark M2 at a position corresponding to the first reference mark M1, and the first and second thin metal plates 18a and 18b are laminated one on the other to make the first and second reference marks M1 and M2 coincide, thereby directing the directions of the warps W in the same direction. Even if the warps W are hard to identify or distinguish, the first and second thin metal plates 18a and 18b can be laminated with the warps W coinciding with each other.

(3) In the fluid control valve 10 mentioned in (2), the first reference mark M1 is provided in the form of the first cutout end C1 formed by cutting a part of the first thin metal plate 18a and the second reference mark M2 is provided in the form of the second cutout end C2 formed by cutting a part of the second thin metal plate 18b. Accordingly, the first and second thin metal plates 18a and 18b have only to be laminated so that the first and second cutout ends C1 and C2 are aligned to easily make the warps W of the first and second thin metal plates 18a and 18b coincide.

### Third Embodiment

A third embodiment of the invention will be described below.

The third embodiment is substantially the same in structure as the first embodiment excepting the configurations of the first and second thin metal plates 18a and 18b. The following explanation is therefore made with a focus on the differences.

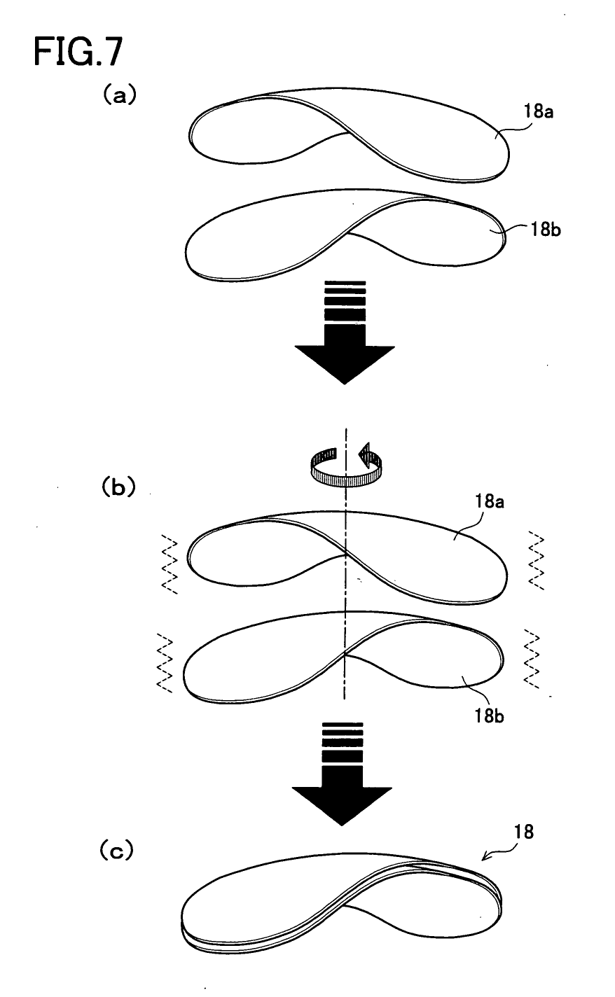

FIG. 6 is a schematic view showing a state where the first thin metal plate 18a and the second thin metal plate 18b are laminated one on the other.

In this embodiment, the first thin metal plate 18a is provided with a first protrusion D1 and the second thin metal plate 18b is provided with a second protrusion D2. These protrusions D1 and D2 are formed by for example pressing parts of the metal plates 18a and 18b respectively. When the first and second thin metal plates 18a and 18b are to be laminated, the first and second protrusions D1 and D2 are aligned with each other. Thus, the first and second thin metal plates 18a and 18b can be laminated so that the directions of respective warps W coincide with each other to form the metallic diaphragm 18.

Those first and second protrusions D1 and D2 formed in the first and second thin metal plates 18a and 18b as above can facilitate lamination of the metal plates 18a and 18b with the warps W coinciding with each other. Further, the first and second protrusions D1 and D2 may be formed in conical shape to achieve automatic alignment. This can further facilitate to direct the warps W in the same direction.

However, the first and second protrusions D1 and D2 are preferred to be provided without falling within the peripheral end 18s of the metallic diaphragm 18 in order to ensure the sealing capability. If those protrusions D1 and D2 are provided in a portion of the metallic diaphragm 18 which comes into contact with the valve seat element 15, fluid leakage may be caused even in the valve closed condition of the fluid control valve 10.

On the other hand, if the protrusions D1 and D2 are provided in the center portion of the metallic diaphragm 18, the protrusions D1 and D2 may not serve appropriately because the thin metal plates 18a and 18b are circular. Moreover, it is undesirable to provide the first and second protrusions D1 and D2 in portions which may interfere with motions of the metallic diaphragm 18. In light of the aforementioned, the protrusions D1 and D2 is preferably provided just near the peripheral end 18s for example.

The third embodiment having the above configuration can also reduce variations in lift amount R, enhance flow rate characteristics of the fluid control valve 10, and increase action durability of the metallic diaphragm 18.

The fluid control valve 10 of the third embodiment mentioned above can exhibit the following configuration, operations, and advantages.

(1) The fluid control valve 10 includes the metallic diaphragm 18 which is formed of a plurality of circular thin metal plates and moved into and out of contact with the valve seat element 15 for valve closing and opening. In this valve 10, the first and second circular thin metal plates 18a and 18b are laminated one on the other with the directions of respective warps W coinciding with each other. Accordingly, the metallic diaphragm 18 formed of the first and second thin metal plates 18a and 18b whose warps W coincide is mounted in the fluid control valve 10.

As above, the first and second thin metal plates 18a and 18b are laminated with the warps W coinciding and mounted as the metallic diaphragm 18 in the fluid control valve 10. This makes it possible to reduce variations in lift amount R of the metallic diaphragm 18 during operation of the fluid control valve 10 to allow fluid to flow.

(2) In the fluid control valve 10 mentioned in (1), the first thin metal plate 18a is formed with the first reference mark M1 and the second thin metal plate 18b is formed with the second reference mark M2 at a position corresponding to the first reference mark M1, and the first and second thin metal plates 18a and 18b are laminated one on the other to make the first and second reference marks M1 and M2 coincide, thereby directing the directions of the warps W in the same direction. Even if the warps W are hard to identify or distinguish, the first and second thin metal plates 18a and 18b can be laminated with the warps W coinciding with each other.

In the fluid control valve 10 mentioned in (2), the first reference mark M1 is provided in the form of the first protrusion D1 formed by pressing a part of the first thin metal plate 18a and the second reference mark M2 is provided in the form of the second protrusion D2 formed by pressing a part of the second thin metal plate 18b. Accordingly, the first and second thin metal plates 18a and 18b have only to be laminated so that the first and second protrusions D1 and D2 are aligned to easily make the warps W of the first and second thin metal plates 18a and 18b coincide.

Furthermore, the protrusions D1 and D2 put one on the other can prevent the first and second thin metal plates 18a and 18b from becoming displaced after lamination, and hence avoid displacement of the warps W when the metallic diaphragm 18 is mounted in the fluid control valve 10.

### Fourth Embodiment

A fourth embodiment of the invention will be described below.

The fourth embodiment is substantially the same in structure as the first embodiment excepting the configurations of the first and second thin metal plates 18a and 18b. The following explanation is therefore made with a focus on the differences.

FIG. 7 is a schematic view showing a state where the first thin metal plate 18a and the second thin metal plate 18b are laminated one on the other. In FIG. 7, (a) shows a state where the first and second thin metal plates 18a and 18b are temporarily laminated or assembled, (b) shows a state where the plates 18a and 18b are vibrated, and (c) shows a state where the plates 18a and 18b are completely laminated.

In this embodiment, as shown in the state (a) of FIG. 7, the first thin metal plate 18a and the second thin metal plate 18b are temporarily laminated at first. At this time, the warps W of the first and second thin metal plates 18a and 18b need not to coincide with each other.

Then, the metallic diaphragm 18 temporarily assembled as shown in FIG. 7 (a) is vibrated as shown in FIG. 7 (b). This vibration may be made for example by providing a vibration table, placing the temporarily assembled metallic diaphragm 18 thereon, and slightly vibrating the metallic diaphragm 18.

The thus vibrated first and second thin metal plates 18a and 18b attempt to move toward the directions where the plates 18a and 18b more easily overlap exactly with each other.

As a result, the first thin metal plate 18a misaligned with the second thin metal plate 18b, for example, is moved or turned toward a position where the respective warps W coincide with each other. In this way, the metallic diaphragm 18 with the respective warps W coincident with each other can be obtained as shown in FIG. 7 (c).

Mostly, the first and second thin metal plates 18a and 18b have warped (W) along with the rolling direction. These plates 18a and 18b are formed through the same process and accordingly, warped similarly. Therefore, the above application of vibration to the first and second thin metal plates 18a and 18b can make alignment of the warps W of the plates 18a and 18b.

No other complex processes besides the application of vibration are needed to make the respective warps W of the first and second thin metal plates 18a and 18b coincident with each other.

The fourth embodiment having the above configuration can also reduce variations in lift amount R, enhance flow rate characteristics of the fluid control valve 10, and increase action durability of the metallic diaphragm 18. Further, the fourth embodiment may be combined with any one of configurations of the first to third embodiments to ensure the alignment of the respective warps W and the rolling direction of the first and second thin metal plates 18a and 18b.

The fluid control valve 10 of the fourth embodiment mentioned above can exhibit the following configuration, operations, and advantages.

(1) The fluid control valve 10 includes the metallic diaphragm 18 which is formed of a plurality of circular thin metal plates and arranged to move into and out of contact with the valve seat element 15 for valve closing and opening. In this valve 10, the first and second circular thin metal plates 18a and 18b are laminated one on the other with the directions of respective warps W coinciding with each other. Accordingly, the metallic diaphragm 18 formed of the first and second thin metal plates 18a and 18b whose warps W coincide is mounted in the fluid control valve 10.

As above, the first and second thin metal plates 18a and 18b are laminated with the warps W coinciding and mounted as the metallic diaphragm 18 in the fluid control valve 10. This makes it possible to reduce variations in lift amount R of the metallic diaphragm 18 during operation of the fluid control valve 10 to allow fluid to flow.

(2) In the fluid control valve 10 mentioned in (1), the first thin metal plate 18a is formed with the first reference mark M1 and the second thin metal plate 18b is formed with the second reference mark M2 at a position corresponding to the first reference mark M1, and the first and second thin metal plates 18a and 18b are laminated one on the other to make the first and second reference marks M1 and M2 coincide, thereby directing the directions of the warps W in the same direction. Even if the warps W are hard to identify or distinguish, the first and second thin metal plates 18a and 18b can be laminated with the warps W coinciding with each other.

(3) The fluid control valve 10 mentioned in (1) or (2) includes the first and second thin metal plates 18a and 18b that are assembled in such a way that they are temporarily laminated and then vibrated to make the respective warps W coincide with each other. For the purpose, the first and second thin metal plates 18a and 18b have only to be temporarily laminated and then vibrated to make the respective warps W coincide along with the rolling direction.

This application of vibration to the first and second thin metal plates 18a and 18b allows the plates to move or turn, causing the respective warps W to coincide with each other when the warps W of the first and second thin metal plates 18a and 18b are large enough to be identified.

While the presently preferred embodiments of the present invention have been shown and described, it is to be understood that various changes and modifications may be made without departing from the scope of the invention.

In the present embodiments, the first thin metal plate 18a and the second thin metal plate 18b are laminated one on the other to form the metallic diaphragm 18, but the number of plates to be laminated can be appropriately changed in conformity with required rigidity or the like. The number is not limited to two. More plates are laminated to form the metallic diaphragm 18 resulting in the increase of the laminating times, more risk there is that the respective warps W are misaligned. Therefore, the technique of the present embodiments is more effective when the number of the plates is multiplied.

In the first embodiment, the first and second thin metal plates 18a and 18b are marked by means of a laser marker, but it is not limited to the laser marker for marking as long as marking is made appropriately.

Furthermore, even though materials for the passage block 11, the metallic diaphragm 18 and others are indicated in the first to fourth embodiments, they are not limited by these embodiments, either.

In addition, the shape of the first and second thin metal plates 18a and 18b is determined by the shape of the metallic diaphragm 18, but other shapes besides the circular shape may be selected in accordance with for example the shape of the passage block 11 of the fluid control valve 10 or the connecting part of the drive unit 20.

What is claimed is:

1. A fluid control valve comprising:
a valve seat; and
a diaphragm formed of a plurality of circular thin metal plates laminated one on another, the diaphragm being placed to be movable into or out of contact with the valve seat for closing and opening the valve;
wherein each thin metal plate has a warp in a predetermined direction, and
the thin metal plates constituting the diaphragm are laminated with the directions of respective warps coinciding with one another.

2. The fluid control valve according to claim 1, wherein
each thin metal plate has rolling anisotropy and the warp that has occurred after each thin metal plate has been shaped into a circular form.

3. The fluid control valve according to claim 1, wherein
the thin metal plates include a first thin metal plate and a second thin metal plate,
the first thin metal plate is formed with a first reference mark on a part of a surface thereof,
the second metal plate is formed with a second reference mark on a part of a surface thereof at a position corresponding to the first reference mark, and
the first and second thin metal plates are laminated so that the first and second reference marks are aligned with each other to make the respective warps coincide with each other.

4. The fluid control valve according to claim 2, wherein
the thin metal plates include a first thin metal plate and a second thin metal plate,
the first thin metal plate is formed with a first reference mark on a part of a surface thereof,
the second metal plate is formed with a second reference mark on a part of a surface thereof at a position corresponding to the first reference mark, and
the first and second thin metal plates are laminated so that the first and second reference marks are aligned with each other to make the respective warps coincide with each other.

5. The fluid control valve according to claim 3, wherein
the first reference is provided in the form of a first cutout end, and
the second reference is provided in the form of a second cutout end.

6. The fluid control valve according to claim 4, wherein
the first reference is provided in the form of a first cutout end, and
the second reference is provided in the form of a second cutout end.

7. The fluid control valve according to claim 3, wherein
the first reference is provided in the form of a first protrusion formed by pressing a part of the first thin metal plate, and
the second reference is provided in the form of a second protrusion formed by pressing a part of the second thin metal plate.

8. The fluid control valve according to claim 4, wherein
the first reference is provided in the form of a first protrusion formed by pressing a part of the first thin metal plate, and
the second reference is provided in the form of a second protrusion formed by pressing a part of the second thin metal plate.

9. The fluid control valve according to claim 1, wherein
the thin metal plates include a first thin metal plate and a second thin metal plate that are laminated in such a manner that they are temporarily assembled and then vibrated to make the respective warps coincide with each other.

10. The fluid control valve according to claim 2, wherein
the thin metal plates include a first thin metal plate and a second thin metal plate that are laminated in such a manner that they are temporarily assembled and then vibrated to make the respective warps coincide with each other.

11. The fluid control valve according to claim 3, wherein
the first thin metal plate and the second thin metal plate are laminated in such a manner that they are temporarily assembled and then vibrated to make the respective warps coincide with each other.

12. The fluid control valve according to claim 4, wherein
the first thin metal plate and the second thin metal plate are laminated in such a manner that they are temporarily assembled and then vibrated to make the respective warps coincide with each other.

13. The fluid control valve according to claim 5, wherein
the first thin metal plate and the second thin metal plate are laminated in such a manner that they are temporarily assembled and then vibrated to make the respective warps coincide with each other.

14. The fluid control valve according to claim 6, wherein
the first thin metal plate and the second thin metal plate are laminated in such a manner that they are temporarily assembled and then vibrated to make the respective warps coincide with each other.

15. The fluid control valve according to claim 7, wherein
the first thin metal plate and the second thin metal plate are laminated in such a manner that they are temporarily assembled and then vibrated to make the respective warps coincide with each other.

16. The fluid control valve according to claim 8, wherein
the first thin metal plate and the second thin metal plate are laminated in such a manner that they are temporarily assembled and then vibrated to make the respective warps coincide with each other.
